(19) United States
(12) Patent Application Publication
(10) Pub. No.: US 2020/0151928 A1
(43) Pub. Date: May 14, 2020

(54) AUTOGRAPH AUTHENTICATION

(71) Applicant: twineSTUDIO, LLC, Toledo, OH (US)

(72) Inventors: Jon Hawker, Perrysburg, OH (US); Tanner Clayton, Perrysburg, OH (US); Chris Hawker, Columbus, OH (US)

(21) Appl. No.: 16/678,160

(22) Filed: Nov. 8, 2019

Related U.S. Application Data
(60) Provisional application No. 62/757,218, filed on Nov. 8, 2018.

(51) Int. Cl. G06T 11/60

(52) U.S. Cl. CPC G06T 11/60

(57) ABSTRACT

Pairing a digital media file with a digital autograph can be achieved with systems and methods that verifying an identity of the user. A digital media file including at least one image and a digital autograph including text are each selected. The selected digital media file and the selected digital autograph are combined into a combined media file that is certified by the user. Output of the combined media file can therefore provide an authenticated and autographed media product.

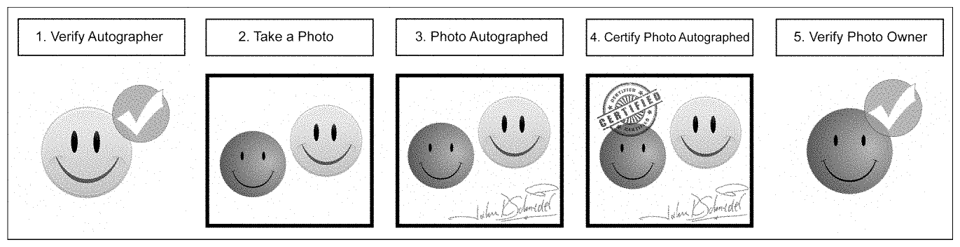

### CROSS-REFERENCE TO RELATED APPLICATIONS

This application claims the benefit of U.S. Provisional Application No. 62/757,218, filed on Nov. 8, 2018. The entire disclosure of the above application is incorporated herein by reference.

### FIELD

The present technology relates to ways of verifying and certifying a digital media file paired with a digital autograph.

### INTRODUCTION

This section provides background information related to the present disclosure which is not necessarily prior art.

Various situations and opportunities exist for interactive autography and dedication of physical and digital products between a signatory and one or more persons having an interest in the signatory. For example, various persons have an interest in acquiring physical and/or digital mementos to record or memorialize an event, concert, sporting contest, encounter, or meeting with a signatory or certain persons simply desire a keepsake or other memorabilia as a tangible reminder of one's admiration for a particular signatory. Such signatories can include various athletes, actors, artists, authors, musicians, media personalities, popular culture personas, digital media influencers, politicians, corporate executives, and other types of celebrities or popular culture icons. Examples include fans having an interest having various products or articles autographed, sometimes along with a personalized dedication, by the signatory.

Obtaining a signed and/or dedicated memento can create a personal connection between the signatory and the recipient/purchaser of a product or service that emanates from or is being promoted by the signatory. For example, an athlete can be promoting his or her sports team at various public relation events and/or sporting events, an actor can be promoting a new movie release, a band can be promoting their latest album, an author can be signing copies of his or her book on a book tour, etc. In certain circumstances, signatories may sign and include personalized dedications to fans on various memorabilia such as photographs, sports programs, jerseys, sporting equipment, posters, books, and other souvenirs and promotional materials.

Distribution of traditional media, such as autographed souvenirs and books, has shown the value of enabling personal interaction between celebrities and their fans. Personal interaction can humanize the celebrity, create a sense of immediacy and connection in the fan toward the celebrity, which in turn can inspire loyalty in the fan, and make the fan invested in the success of the celebrity and his/her products or services. The same can be true for celebrities who promote the sale of products or services associated with their brand and persona. The personal interaction for traditional media, practically, often takes the form of signings/dedications such as book signings, CD signings, or signing of other memorabilia. These personal interactions can help celebrities cultivate a likeable and accessible image and can help them promote their products/services or the products/services of others that they have endorsed. This type of accessibility can increase the appeal of celebrities who participate in such activities, even with those fans who do not take part in the signings/dedications themselves.

Increasingly, such autographed or personalized memorabilia or souvenirs are no longer limited to physical products, but rather can include or can even be replaced by digital products, such as electronic media files, digital photographs, e-books, electronic music files, movie downloads, data streams of musical content, e-art, or other digital entertainment content. Sale and distribution of such digital products can benefit by rapid generation, transfer, and distribution through the use of various portable electronic devices, including smart phones, and wireless or cellular data transfer means. In addition to the advantages of electronic distribution of digital media, the sale/distribution of such media can continue to coincide with a face-to-face meeting between the recipient/purchaser and the signatory/celebrity, especially where a photograph or likeness of the celebrity or other memorabilia is signed and even personalized or dedicated by the signatory to the recipient/purchaser. One way to memorialize an encounter, for example, is to capture a photograph of the celebrity or to take a “selfie” that includes the celebrity with the fan.

However, aspects of digital media include the ability to alter, edit, and even fabricate digital images, audio, and/or video clips, as well as forge signatures, where such can be combined to produce unauthorized copies or imitations of souvenirs or other personalized memorabilia. Fans desire for authentic products having authentic autographs has been met with various ways of certifying authenticity of such products. There is accordingly a concern in distinguishing authentic products with copies or knock-offs that can be increasingly easier to make and harder to discern from the real item.

Consequently, there is a need to verify and certify various types of digital media, including the combination of digital images, audio, and/or video clips with autographs and/or personalized dedications. In this way, fans and other persons who experience the digital media can be assured as to the genuine nature of the product and the signatory or celebrity can be assured that the product is authentic and not an unauthorized copy. The value attributed to autographed items by fans and celebrities alike can therefore be preserved though such verification and certification.

### SUMMARY

The present technology includes systems and processes that relate to pairing a digital media file with a digital autograph, where the combined output results from verification and certification requirements.

Ways for a user, such as a celebrity, to pair a digital media file with a digital autograph are provided that can include the following operations. An identity of the user can be verified. For example, the celebrity can verify his/her identity through recognition of a biometric factor; e.g., a fingerprint. A digital media file including at least one image can be selected by the user; e.g., the image can include a likeness of the celebrity. The digital media file can further include a likeness of a person other than the user; for example, the digital media file can be a photograph of the user and the person other than the user. A digital autograph including text having an autograph of the user can be selected by the user. The text of the digital autograph can include a personalized message or dedication by the user to the person other than the user, for example. The selected digital media file and the selected digital autograph can be combined into a combined media file. The combined media file can be certified by the user and a unique identifier can be added to the combined media file. A celebrity, for example, can certify the combined media file by addition of the unique identifier having a watermark and certain metadata associated with the combined media file. The combined media file can then be provided as an output, where the output of the combined media file can include transferring ownership of the combined media file and a transfer of consideration. Transfer, as well as certification, can be monitored and recorded using a secure means, such as a blockchain to minimize any modification of the combined media file. For example, where the user is a celebrity such as an athlete, actor, author, politician or other famous persona and the person other than the user is a fan or supporter of the user, the user (e.g., athlete) transfers ownership of the combined media file to the person other than the user (e.g., fan) as part of a promotional event or in exchange for a transfer of consideration (e.g., payment).

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of a selected embodiment and not all possible implementations, and is not intended to limit the scope of the present disclosure.

The FIGURE schematically illustrates a way for a user to pair a digital media file including a digital photograph with a digital autograph.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the FIGURES. Spatially relative terms may be intended to encompass different orientations of the device in use or operation in addition to the orientation depicted in the FIGURES. For example, if the device in the FIGURES is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology allows a user to pair a digital media file with a digital autograph by performing the following operations. An identity of the user is verified. A digital media file including at least one image is selected by the user and a digital autograph including text is selected by the user. The selected digital media file and the selected digital autograph are combined into a combined media file, which is certified by the user. The combined media file is provided as an output. Various systems, processes, non-transitory electronic media, and devices can be used and/or configured to carry out these operations.

Verification of the identity of the user can occur at the outset. In this way, the process can continue only when the identity of the user is verified with a predetermined confidence. The verification can also place control of any output with the user and prevent completion of the process and/or operation of system components without the user's consent. Various ways of verifying a user's identity can be employed, including various ways known for accessing portable electronic devices, such as smart phones, tablets, and other computing devices. Certain embodiments include where verifying the identity of the user includes entering a knowledge factor, such as by entering a password and/or answering a question. An inherent factor can also be provided, including recognition of a biometric factor such as facial recognition, fingerprint recognition, voice recognition, iris recognition. Multi-factor authentication can be employed, by providing two-factor authentication, including entry of a possession factor, entry of a disconnected token, entry of a connected token, and entry of a software token. Combinations of such verifying procedures can also be used.

The user can select the digital media file including at least one image in various ways. The at least one image of the digital media file can include a likeness of the user, such as a stylized likeness using a digital filter or image modification means, a cartoon or drawing, a caricature, a photograph or modified photograph. The at least one image of the digital media file can also include a likeness of a person other than the user, which can be presented in a similar or different way than the likeness of the user. In certain embodiments, where the at least one image of the digital media file includes a likeness of the user and the likeness of a person other than the user, the image can be a photograph or “selfie” taken of the user and the person other than the user. The digital media file can also be selected from a database including more than one digital media files. For example, it may be desired that the likeness of the user be selected from a photographs of the user in a sports uniform or dressed as a certain movie character. The digital media file can also be generated substantially contemporaneously with the selecting, by the user, of the digital media file. It is also possible to apply various digital filters and modifications at the same time, or to add additional images, logos, characters, symbols, numbers, etc. The digital media file can further include an animation and/or an audio recording; e.g., a clip of a game winning goal, a famous movie line, or other event. The user can also select the digital media file including at least one image based upon a request by the person other than the user.

The user can select the digital autograph including text in various ways. The text of the digital autograph can include an autograph of the user as well as a personalized dedication or message. In certain embodiments, the digital autograph can be selected from a database including multiple digital autographs with and without multiple dedications/messages. Selection of the digital autograph in this manner can save time by the user. However, the selection of the digital autograph can include selecting a digital autograph generated substantially contemporaneously with the selecting, by the user, of the digital autograph. That is, the user can generate and select a new digital autograph having text of the user's name and a personalized dedication. The digital autograph can also include an animation and/or an audio recording. For example, the user's autograph can be animated and appear to be written in realtime and the personalized dedication can be an audio recording.

Combination of the selected digital media file and the selected digital autograph into a combined media file can include the following aspects. The digital media file can be generated and/or selected by using a portable electronic device, such as a smart phone having a camera, or in communication with another device having a camera and optionally a microphone. The digital autograph can be generated and/or selected in a similar fashion. For example, the user can scroll through a database of digital media files and digital autographs in the selection thereof, where the selections are then paired and combined into the combined media file using an image processing device, application, and/or software that can permit overlaying the digital autograph on a portion of the at least one image of the digital media file. The combination can also be done side-by-side, top and bottom, or other arrangements as selected by the user.

It should be understood that the selecting of the digital media file including at least one image and the selecting of digital autograph including text by the user can include tacit approval or selection by the user. For example, the person other than the user (e.g., a fan) may select a digital media file including an image of the user (e.g., an athlete) in a home game sports uniform and may select a digital autograph including text having a dedication to the fan and an autograph by the user. The athlete can then tacitly select/approve the fan's selections when certifying the combined media file. In this way, the fan can customize the imagery and autograph (along with any additional animation, audio, etc.) and the athlete can approve the fan's choices by selecting them and certifying them to form the combined media file. In certain instances, the user/athlete may not approve of a particular combination, where the fan can be afforded an opportunity to modify the selection(s) or the user/athlete can modify one or both selections. As such, selection of the digital media file including the at least one image and selection of the digital autograph including text can be done by the user, the person other than the user, or both.

Certification of the combined media file can be accomplished by the user in various ways. The certifying can include confirming the combined media file is acceptable to the user. By accepting the combined media file, a unique identifier can be associated with the combined media file. For example, the unique identifier can include one or more of a digital watermark, metadata, a serial number, a global positioning system location, a date, and a photograph of the user taken substantially contemporaneously with the combining of the selected digital media file and the selected digital autograph into the combined media file. Various types of security features can be included with the certifying and the addition of the unique identifier, including, for example, encryption of the combined media file and monitoring and recording transfer of the combined media file using various secure transmission protocols, networks, and tracking by digital ledgers, such as those used by blockchains and variants thereof. Accessing, viewing, playing, displaying, and/or printing of the combined media file can also be protected by requiring some type of verification, including the examples described herein for verifying the identity of the user; e.g., one or more of entering a knowledge factor, entering a password, answering a question, providing an inherent factor, recognizing a biometric factor, providing facial recognition, providing fingerprint recognition, providing voice recognition, providing iris recognition, providing multi-factor authentication, providing two-factor authentication, entering a possession factor, entering a disconnected token, entering a connected token, and entering a software token. The certification operation can ensure that the combined media file is authentic and can ensure the combined media file originates from the user with the user's approval.

Output of the combined media file can include the following aspects. Outputting can involve transforming the combined media file into a tangible form, including displaying the at least one image from the digital media file and displaying the text of the digital autograph that were combined into the combined media file. Display can include display on a screen, a webpage, “wallpaper” or background of an electronic device such as a smart phone, tablet, or computer, display on an article of manufacture such as an article of clothing, mug or cup, poster, picture. Displaying can include playing any animations and/or audio components associated with the digital medial file and digital autograph forming the combined media file. In certain embodiments, outputting the combined media file can include transferring ownership or providing a license of use for the combined media file. For example, the user (e.g., the celebrity) can transfer ownership or license the combined media file to the person other than the user (e.g., the fan). Transferring ownership of the combined media file can include use of a blockchain to record the transfer. What is more, transferring ownership or use of the combined media file can include a transfer of consideration, such as a payment by the person other than the user (e.g., the fan) in exchange for ownership and/or use of the combined media file. Use of the combined media file can be limited in scope to certain activities, display methods, output to certain objects, time periods, geographic limits, display instances, etc. Certain embodiments include where outputting the combined media file includes using the combined media file as an entry ticket to an event. For example, the combined media file can operate as a verified and certified admission ticket or pass. The combined media file can also be output by printing an image of the combined media file on one or more of a sheet of paper, a drinking vessel, an article of clothing, and a souvenir. Other embodiments include where the combined media file is output by displaying the combined media file on at least one screen, such as the screen of an electronic device, an outdoor display, a movie screen, a stadium display, a scoreboard, etc.

Systems, processes, and articles of manufacture output by the present technology can further include one or more of the following aspects. In certain embodiments, a system is provided for creating digital photographs accompanied by a digital signature (autograph) whereby the authenticity of the autograph and the image is authenticated. Authentication of the combined photograph and autograph can be by the use of blockchain technology, private network, or proprietary system. The photograph and associated autograph can be created by the user or autographer at a time substantially contemporaneous with when the photograph was taken. Examples include autographed photos of a celebrity, celebrity with a fan, or any other circumstance where having an authenticated photo with an autograph is valuable. Other circumstances include generation of security passes, where the combined media file can operate as identification or a security pass or clearance. For example, the user can be in charge of security and tasked with generating passes to enter a secure area. An autograph can include a personalized message to the autograph recipient. The system can be designed to be run on mobile devices, tablets, or other devices with integrated cameras and touchscreens enabling digital autographs. Photographs can be taken in the moment or retrieved/uploaded from a photo library. Autograph authentication can use facial recognition, thumbprint recognition, or other authentication technology such as text, email, or social media account authentication sent to the autographer to verify their identity.

Once authenticated, the autographed image can be saved with a unique digital watermark and unique metadata. The metadata can include an assigned serial number or other unique identifier. The unique identifier can be searchable on a computer or from a database, whereby the metadata accompanying the unique identifier can include any of the following: GPS location, date the photograph or autograph were taken and/or signed, a photo of the autographer during the creation of the autograph, and the like. The ownership of the authenticated digital photo with autograph can be transferred. Ownership transfer may be through a technology such as blockchain.

Pre-authentication of photograph can be reviewed and rejected before finalized. Once authenticated the authenticated autograph can be permanently associated with the digital asset it was written on. Autographed photo can have special effects such as filters, live filters, emojis, digital props, etc. The writing of the autograph can be animated and the autograph can overlay a GIF, Boomerang, video clip, 3D animation or other digital asset. The autographed image may be used as an entry ticket to an event.

Systems and processes described herein can be integrated with an e-commerce function whereby the autograph recipient pays for the autograph. The autographed image can be integrated with an e-commerce function whereby the recipient can purchase a printed copy of the photograph on photo paper, mugs, t-shirt, etc. A receipt can be sent to the recipient. The authenticated autograph can be stored in a database or gallery. It is also possible to provide a gamification of a collection of autographs such as the entire cast of a television or movie. Such games can include badges and can be on a centralized photo taking system or personal mobile device.

With reference now to the FIGURE, aspects of an embodiment of a method for a user to pair a digital media file with a digital autograph are shown.

In the first block, an identity of the user is verified. For example, the user can be a signatory that provides an autograph to a person other than the user. In the second block, the user selects a digital media file including at least one image. As shown, the digital media file including at least one image includes a photograph of the user and the person other than the user. For example, a fan or a celebrity can take a “selfie” that includes both individuals. In the third block, the user can select a digital autograph including text, where the text can include an autograph of the user. The digital autograph can be created and selected by the user at the moment or can be selected from a database and modified to be personalized or include a dedication, etc. The third block also represents a combination of the selected digital media file and the selected digital autograph into a combined media file, where the “selfie” that includes both the celebrity and the fan is positioned along with the digital autograph. The user can then certify the combined media file, as shown in the fourth block. Certification is shown by the addition of a unique identifier embodied as a watermark on the combined media file, illustrated by the “certified” stamp shown on the upper left corner in the fourth block. The combined media file can then be output, as shown in the fifth block, where ownership of the combined media file can be transferred to the person other than the user. For example, a blockchain can be used to record exchange of the combined media file for monetary consideration between the user (e.g., celebrity) and the person other than the user (e.g., fan). Output of the certified combined media file, as shown in the fourth block, can then be displayed on a screen, a souvenir, or other article of manufacture.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method for a user to pair a digital media file with a digital autograph, the method comprising:
verifying an identity of the user;
selecting a digital media file including at least one image;
selecting a digital autograph including text;
combining the selected digital media file and the selected digital autograph into a combined media file;
certifying, by the user, the combined media file; and
outputting the combined media file.

2. The method of claim 1, wherein verifying the identity of the user includes a member selected from a group consisting of: entering a knowledge factor; entering a password; answering a question; providing an inherent factor; recognizing a biometric factor; providing facial recognition; providing fingerprint recognition; providing voice recognition; providing iris recognition; providing multi-factor authentication; providing two-factor authentication; entering a possession factor; entering a disconnected token; entering a connected token; entering a software token; and combinations thereof.

3. The method of claim 1, wherein the at least one image of the digital media file includes a likeness of the user.

4. The method of claim 3, wherein the at least one image of the digital media file further includes a likeness of a person other than the user.

5. The method of claim 4, wherein the likeness of the user and the likeness of the person other than the user includes a photograph of the user and the person other than the user.

6. The method of claim 1, wherein the digital media file is selected from a database including a plurality of digital media files.

7. The method of claim 1, wherein the digital media file is generated substantially contemporaneously with the selecting, by the user, of the digital media file.

8. The method of claim 1, wherein the digital media file includes a member selected from a group consisting of: an animation; an audio recording; and combinations thereof.

9. The method of claim 1, wherein the text of the digital autograph includes an autograph of the user.

10. The method of claim 1, wherein the text of the digital autograph includes a personalized message by the user.

11. The method of claim 1, wherein the digital autograph is selected from a database including a plurality of digital autographs.

12. The method of claim 1, wherein the digital autograph is generated substantially contemporaneously with the selecting, by the user, of the digital autograph.

13. The method of claim 1, wherein the digital autograph includes a member selected from a group consisting of: an animation; an audio recording; and combinations thereof.

14. The method of claim 1, wherein certifying, by the user, of the combined media file includes adding a unique identifier to the combined media file.

15. The method of claim 14, wherein the unique identifier includes a member selected from a group consisting of: a digital watermark; metadata; a serial number; a global positioning system location; a date; a photograph of the user taken substantially contemporaneously with the combining of the selected digital media file and the selected digital autograph into the combined media file; and combinations thereof.

16. The method of claim 1, wherein outputting the combined media file includes transferring ownership of the combined media file.

17. The method of claim 16, wherein transferring ownership of the combined media file includes using a blockchain to record the transfer.

18. The method of claim 16, wherein transferring ownership of the combined media file includes a transfer of consideration.

19. The method of claim 1, wherein outputting the combined media file includes using the combined media file as an entry ticket to an event.

20. The method of claim 1, wherein outputting the combined media file includes printing an image of the combined media file on a member selected from a group consisting of: a sheet of paper; a drinking vessel; an article of clothing; a souvenir; and combinations thereof.

21. The method of claim 1, wherein outputting the combined media file includes displaying the combined media file on at least one screen.

22. A method for a user to pair a digital media file with a digital autograph, the method comprising:
verifying an identity of the user;
selecting, by the user, a digital media file including at least one image having a likeness of the user;
selecting, by the user, a digital autograph including an autograph of the user;
combining the selected digital media file and the selected digital autograph into a combined media file;
certifying, by the user, the combined media file and adding a unique identifier to the combined media file; and
outputting the combined media file, wherein the outputting of the combined media file includes transferring ownership of the combined media file and a transfer of consideration.
